(19) United States
(12) Patent Application Publication
(10) Pub. No.: US 2023/0265332 A1
(43) Pub. Date: Aug. 24, 2023

(54) PHASE CHANGE MATERIAL

(71) Applicant: HUBBARD PRODUCTS LIMITED, Ipswich (GB)

(72) Inventors: Yulong DING, Birmingham (GB); Lin CONG, Birmingham (GB); Derek CHAPMAN, Ipswich (GB); Boyang ZOU, Birmingham (GB)

(73) Assignee: HUBBARD PRODUCTS LIMITED, Ipswich (GB)

(21) Appl. No.: 18/000,363

(22) PCT Filed: Jun. 1, 2021
(86) PCT No.: PCT/GB2021/051348

§ 371 Date: Nov. 30, 2022

(30) Foreign Application Priority Data
Jun. 1, 2020 (GB) 2008204.6

(51) Int. Cl. C09K 5/06; F25D 3/00

(52) U.S. Cl. CPC C09K 5/066; F25D 3/00; F25D 2303/085

(57) ABSTRACT

A phase change material includes a salt-water solution having a first salt, a second salt and water; a gelling agent; a thermal conductivity enhancer; and a nucleation agent. The phase change material is suitable for use as a cold storage material, in particular, for maintaining an environment at a temperature of from −15 to −40° C. The phase change material may be used in a cold storage pack.

### FIELD OF THE INVENTION

The present invention relates to a phase change material. In particular, the present invention relates to a phase change material which contains a salt-water solution. The phase change material is particularly suitable for use as a cold storage material.

### BACKGROUND TO THE INVENTION

Phase change materials absorb significant amounts of thermal energy during melting and, conversely, release thermal energy during freezing. Thus, phase change materials typically have a high latent heat, i.e. the energy required to convert a solid into a liquid without the material changing in temperature.

Phase change materials are useful in a large number of different applications one of which is cold storage. Here, the phase change material is cooled to a temperature below its phase change temperature so that it is in a solid form. The solid phase change material will then cool its surrounding environment. Due to the high latent heat, a large amount of thermal energy is absorbed from the environment during transition of the material from a solid to a liquid at its phase transition temperature. This means that phase change materials are very effective at maintaining cool environments over a long period of time.

Phase change materials are therefore used in many domestic and commercial cold storage applications, particularly where electrically powered refrigeration systems are unavailable. For instance, one or more plastic or metal containers holding a phase change material may be used to maintain a cold environment in a vehicle during transportation of perishable goods such as foodstuffs and medicines.

Typically, a phase change material will be frozen, used, refrozen, used and so on in a cycling refrigeration process. For instance, the phase change material may be frozen in a container overnight, with the container inserted into a cold storage vehicle in the morning for delivery of perishables during the day and removed from the vehicle at the end of the day for refreezing of the phase change material overnight.

Aside from the properties mentioned above, phase change materials would ideally have a good cycling stability, low tendency to leak from a container, be non-toxic in the event of any leaks, exhibit low levels of degradation such as bacterial degradation, and possess good heat transfer properties.

Phase change materials with a phase change temperature in the range of −15 to −40° C. are useful for cold storage application. However, cost-effective formulations having a desired combination of properties in this temperature range have been difficult to formulate. In the past, paraffins, alcohol solutions and binary salt-water solutions have most commonly been used in low-cost formulations. However, organic materials may suffer from poor levels of latent heat, suffer from bacterial growth and/or even be toxic. Inorganic salt solutions will often exhibit a higher latent heat, but the range of phase change temperatures available with binary salt-water solutions is limited.

Specialist phase change materials for the above-mentioned temperature range are typically more expensive to prepare, and will often contain a large number of components which can render them unstable. Specialist phase change materials are disclosed in CN 102268240 A, CN 104726071 A, CN 104726072 A and CN 104830283 A. However, these phase change materials tend to still suffer from one or more of the drawbacks listed above. For instance, CN 102268240 A is an over-saturated solution meaning that phase separation will occur over time. Guar gum is therefore used to suspend the precipitated salts in water so that they remain even distributed throughout the material.

There is therefore a need for improved phase change materials, particularly for use in cold storage applications where a phase change temperature in the range of −15 to −40° C. is desired.

### SUMMARY OF THE INVENTION

In a first aspect, the present invention provides a phase change material for use as a cold storage material, said phase change material comprising:
a salt-water solution comprising a first salt, a second salt, and water,
a gelling agent;
a thermal conductivity enhancer; and
a nucleation agent.

The present invention further provides a method of preparing a phase change material of the present invention, said method comprising combining all of the components of the phase change material, preferably by:
preparing a pre-mixture of all of the components in the phase change material apart from the gelling agent; and then
adding the gelling agent to the mixture.

Also provided is a cold storage pack which comprises:
a phase change material of the present invention; and
a container, preferably a plastic container, in which the phase change material is held.

The use of a phase change material of the present invention as a cold storage material, e.g. for maintaining an environment at a temperature of from −15 to −40° C., is also provided.

### DESCRIPTION OF THE FIGURES

FIG. 1 shows the phase change temperature and fusion heat of a variety of phase change materials, including organic materials and eutectic salt solutions.

FIGS. 2a and 2b shows the phase change temperature and latent heat of a variety of sodium chloride-containing ternary salt-water solutions as measured using differential scanning calorimetry (DSC). For comparison, the phase change temperature and latent heat of eutectic sodium chloride is also shown.

### DESCRIPTION OF VARIOUS EMBODIMENTS

The present invention relates to a phase change material for use as a cold storage material. In particular, the present invention relates to a solid-liquid phase change material, i.e. a material that releases or absorbs energy as it transitions between a solid and liquid phase.

The phase change material comprises a salt-water solution; a gelling agent; a thermal conductivity enhancer and a nucleation agent. In some embodiments, the phase change material consists of a salt-water solution; a gelling agent; a thermal conductivity enhancer and a nucleation agent.

### Salt-Water Solution

The salt-water solution that is used in the phase change material of the present invention comprises a first salt, a second salt, and water. Salt-water solutions which comprise at least two salts may advantageously melt at a lower temperature that corresponding solutions of a single salts.

The salt-water solution may comprise salts in addition to the first and second salts. The use of higher numbers of salts in the salt-water solution enables systems with a wide range of phase change temperatures, including very low phase change temperatures, to be successfully tailored. However, as more salts are used, the latent heat of the salt water solution tends to reduce. Accordingly, it is generally desirable to use two or three salts in the salt water solution.

Salt-water solutions in which two salts (i.e. a first salt and a second salt) are used are known as ternary salt-water solutions, since they consist of the first salt, the second salt and water. Similarly, salt-water solutions in which three salts (i.e. a first salt, a second salt and a third salt) are used are known as quaternary salt-water solutions. Particularly preferred for use in the present invention are ternary salt-water solutions.

In preferred embodiments, the cations or the anions in the first and second salts are the same. More preferably, the anions in the first and second salts are the same. Where further salts are present in the salt-water solution, the cations or the anions, and preferably the anions, in each of the salts in the salt-water solution are preferably the same. By using the same cation or anion in the salts, a more defined phase change temperature may be observed in the salt-water solution, perhaps because reactions between the first and second (and optionally further) salts in the phase change material are avoided.

The cations in the first and second salt, and preferably any further salts that form part of the salt-water solution, may be selected from alkali metal (e.g. lithium, sodium and potassium), alkaline earth metal (e.g. calcium and magnesium), transition metal (e.g. zinc, iron and copper) and ammonium cations. In some circumstances, however, the use of transition metal salts may be avoided since these can be corrosive. Thus, the cations are preferably selected from alkali metal, alkaline earth metal, and ammonium cations, and more preferably from alkali metal and ammonium cations, such as sodium and ammonium cations.

Where transition metal cations are used, then the container in which the phase change material is used preferably has an anti-corrosive surface. The anti-corrosive surface may be imparted by the material from which the container as a whole is made or from a coating material on the inner surface of the container. This reduces the corrosion caused by transition metal cations, and therefore the likelihood of container leakage.

The anions in the first and second salt, and preferably any further salts that form part of the salt-water solution, may be selected from nitrate, sulfate, hydrogen sulfate, thiosulfate, phosphate, hydrogen phosphate, dihydrogen phosphate, carbonate, hydrogen carbonate, hydroxide, formate, acetate and halide (e.g. chloride, bromide and iodide) anions. Preferred anions are halides, such as chloride.

The first and second salts, and any further salts that may form part of the salt-water solution, may be organic or inorganic salts. Preferably, the salts are inorganic salts since these tend to inhibit microbial growth, and exhibit good thermal performance.

In preferred embodiments, the first salt is sodium chloride (NaCl). The first salt may be combined with a second salt selected from ammonium chloride (NH₄Cl), potassium chloride (KCl) and sodium sulfate (Na₂SO₄), and preferably from ammonium chloride and potassium chloride.

In particularly preferred embodiments, the first salt is sodium chloride and the second salt in ammonium chloride. It has surprisingly been found that this combination, in a ternary salt-water solution, exhibits a phase change temperature of approximately −25° C., and a high latent heat, making it highly suitable for use in low-temperature cold storage applications.

The salt-water solution is preferably a eutectic solution. Eutectic solutions are well known in the art as multi-component systems that melt and solidify at a single temperature that is lower than the melting point of any of the constituents.

In some embodiments, the salt water-solution is a combination of a first eutectic solution of the first salt, a second eutectic solution of the second salt and, where present, preferably further eutectic solutions of any further salts. Thus, the salt-water solution may be prepared by combining the first eutectic solution with the second eutectic solution, and eutectic solutions of any further salts that may be present. It will be appreciated that two components are present in the first eutectic solution: water and the first salt, and two components are present in the second eutectic solution: water and the second salt, and so on.

Preferably, the first and second eutectic solutions exhibit phase change temperatures which are close to one another. These combinations give a more significant lowering of the phase change temperature of the phase change material. Preferably, the first and second eutectic solutions exhibit phase change temperatures within 10° C., preferably within 8° C., and more preferably within 6° C. of one another. The second eutectic solution may exhibit a phase change temperature which is higher than that of the first eutectic solution, e.g. by at least 1° C., preferably by at least 2° C., and more preferably by at least 3° C. Thus, the second eutectic solution may exhibit a phase change temperature which is from 1 to 10° C., preferably from 2 to 8° C., and more preferably from 3 to 6° C. higher than that of the first eutectic solution.

The first eutectic solution may exhibit a phase change temperature which is higher than, but preferably still fairly close to, that of the phase change material. The phase change temperature of the first eutectic solution may be at least 1° C., preferably at least 1.5° C., and more preferably at least 2° C. higher than that of the phase change material. The phase change temperature of the first eutectic solution may be up to 10° C., preferably up to 7° C., and more preferably up to 5° C. higher than that of the phase change material. Thus, the phase change temperature of the first eutectic solution may be from 1 to 10° C., preferably from 2 to 7° C., and more preferably from 2.5 to 5° C. higher than that of the phase change material.

The latent heat of the phase change material is preferably higher than that of first or second eutectic solution. The latent heat of the phase change material may be at least 10 kJ/kg, preferably at least 20 kJ/kg, and more preferably at least 30 kJ/kg higher than that of the first or second eutectic solution.

The ratio, by weight, of the first salt to the second salt may be at least 1.5:1, preferably at least 2:1, and more preferably at least 2.25:1. The ratio, by weight, of the first salt to the second salt solution may be up to 4:1, preferably up to 3:1, and more preferably up to 2.75:1. Thus, the ratio, by weight, of the first salt to the second salt may be from 1.5:1 to 4:1, preferably from 2:1 to 3:1, and more preferably 2.25:1 to 2.75:1.

The salt-water solution may comprise the first and second salts, and any further salts that may form part of the salt-water solution, in a total amount of at least 15%, preferably at least 20%, and more preferably at least 22% by weight. The salt-water solution may comprise the first and second salts, and any further salts that may form part of the salt-water solution, in a total amount of up to 35%, preferably up to 30%, and more preferably up to 28% by weight. Thus, the salt-water solution may comprise the first and second salts, and any further salts that may form part of the salt-water solution, in a total amount of from 15 to 35%, preferably 20 to 30%, and more preferably from 22 to 28% by weight.

The phase change material may comprise the salt-water solution in an amount of at least 90%, preferably at least 92%, and more preferably at least 93% by weight. The phase change material may comprise the salt-water solution in an amount of up to 97%, preferably up to 96.5%, and more preferably up to 96% by weight. Thus, the phase change material may comprise the salt-water solution in an amount of from 90 to 97%, preferably from 92 to 96.5%, and more preferably from 93 to 96% by weight.

The phase change material will generally comprise water in an amount of at least 60%, preferably at least 65%, and more preferably at least 70% by weight. For the purposes of the present invention, all of the water in the phase change material forms part of the salt-water solution, though it may be added to the phase change material as a carrier for one or more of the other components that may be present. In other words, the preferred proportions of water and salts in the salt-water solution may be formed in situ.

The use of water in such high amounts, though desirable from an economic perspective, has typically been avoided. This is because its low viscosity means that phase change materials with a high water content are particularly prone to leaking, e.g. at the inlet or outlet, or a damaged portion, from a cold storage material container. This problem is addressed by using a gelling agent in the phase change material of the present invention.

### Gelling Agents

Gelling agents increase the viscosity of the phase change material. Gelling agents can function by chemically interacting with the water in the phase change material thereby changing its properties, or by forming a three-dimensional gel network in which water is trapped. Gelling agents may be used to suspend a nucleation agent and/or to reduce the likelihood of leaks from a container.

Suitable gelling agents may be selected from organic gelling agents (e.g. carboxymethyl cellulose, polyacrylamide, starch and xanthan), silica dioxide and mixtures thereof. CMC is particularly suitable.

The phase change material may comprise the gelling agent in an amount of at least 1%, preferably at least 2%, and more preferably at least 3% by weight. The phase change material may comprise the gelling agent in an amount of up to 8%, preferably up to 7%, and more preferably up to 6% by weight. Thus, the phase change material will generally comprise the gelling agent in an amount of from 1 to 8%, preferably from 2 to 7%, and more preferably from 3 to 6% by weight. It will be appreciated that, where more than one gelling agent is used, these amounts refer to the total amount of gelling agent in the phase change material.

The use of a gelling agent in these amounts would usually be avoided as excessively gelled phase change materials may suffer from low thermal conductivity and uneven temperature distribution. However, these drawbacks may be offset in the present invention by the use of thermal conductivity enhancers and nucleation agents.

### Conductivity Enhancer

Thermal conductivity enhancers are materials which improve heat transfer through the phase change material. Thermal conductivity enhancers are typically present as solids—even if dispersed as e.g. nano-scale particles—in the phase change material.

Suitable thermal conductivity enhancers may be selected from carbon-based materials (e.g. graphite such as expansion graphite, carbon nanotubes and carbon fibres), metal-based materials (e.g. metal powder), carbides, and combinations thereof, though other thermally conductive materials that are compatible with the phase change material may also be used. The thermal conductivity enhancer may be in the form of micro- or nano-scale particles. However, metal-based materials are preferably avoided since these can lead to higher levels of corrosion. Accordingly, preferred thermal conductivity enhancers are selected from carbon-based materials and carbides, with carbon-based materials particularly preferred.

The phase change material may comprise the thermal conductivity enhancer in an amount of at least 0.05%, preferably at least 0.1%, and more preferably at least 0.25% by weight. The phase change material may comprise the thermal conductivity enhancer in an amount of up to 2%, preferably up to 1%, and more preferably up to 0.75% by weight. Thus, the phase change material may comprise the thermal conductivity enhancer in an amount of from 0.05 to 2%, preferably from 0.1 to 1%, and more preferably from 0.25 to 0.75% by weight. It will be appreciated that, where more than one thermal conductivity enhancer is used, these amounts refer to the total amount of thermal conductivity enhancer in the phase change material.

### Nucleation Agent

Nucleation agents provide a nucleus around which the salt-water solution may solidify during freezing of the phase change material before use. This is particularly beneficial when the phase change material is eutectic in nature, since the precipitate that is often observed in supersaturated solutions (and which acts as a nucleation agent) will not be present. The use of a nucleation agent in the present invention reduces the extent to which the phase change material needs to be cooled below its phase transition temperature before it solidifies (i.e. it reduces supercooling). The nucleation enhancers are preferably present as solids in the phase change material, though they may also be materials that precipitate from solution above the phase transition temperature.

Suitable nucleation agents may be selected from isotypic nucleation agents (e.g. borax), non-isotypic nucleation agents (e.g. dilatometer and silica) and mixtures thereof. Isotypic nucleation agents are preferred, in particular borax.

The phase change material may comprise the nucleation agent in an amount of at least 0.05%, preferably at least 0.1%, and more preferably at least 0.25% by weight. The phase change material may comprise the nucleation agent in an amount of up to 2%, preferably up to 1%, and more preferably up to 0.75% by weight. Thus, the phase change material may comprise the nucleation agent in an amount of from 0.05 to 2%, preferably from 0.1 to 1%, and more preferably from 0.25 to 0.75% by weight. It will be appreciated that, where more than one nucleation agent is used, these amounts refer to the total amount of nucleation agent in the phase change material.

### Phase Change Material Properties

The phase change material of the present invention may exhibit a phase change temperature which makes it particularly suitable for certain cold storage applications. For these applications, the phase change material of the present invention preferably exhibits a phase change temperature of at −15° C. or lower, preferably −20 or lower, and more preferably from −24 or lower. The phase change material of the present invention may exhibit a phase change temperature of −40° C. or higher, preferably −30° C. or higher, and more preferably −26° C. or higher. Thus, the phase change materials of the present invention preferably exhibits a phase change temperature of from −40° C. to −15° C., preferably from −30 to −20° C., and more preferably from −26 to −24° C.

However, the principle of the invention may be applied more broadly, for instance to phase change materials that exhibit a phase change temperature of from −70 to 0° C.

The phase change temperatures described herein may be measuring using differential scanning calorimetry (DSC), e.g. using a method as detailed in the examples. Preferably, the phase change temperatures described herein are determined using, for example ASTM E794—06 (2018), DIN 51004: 1994 or ASTM D3418—15, and calibration may be performed according to ASTM E967—18.

The phase change material of the present invention may advantageously also exhibit a high latent heat of enthalpy. The phase change material may have a latent heat of enthalpy of greater than 150 kJ/kg, preferably greater than 175 kJ/kg, and more preferably greater than 200 kJ/kg.

The latent heats described herein may be measured using DSC, e.g. using a method as detailed in the examples. Preferably, the latent heats described herein are determined using, for example ASTM E793—06 (2018) or ASTM D3418—15, and calibration may be performed according to ASTM E968—02 (2014).

One advantage of the present invention is that, unlike many prior art cold storage materials, the phase change material may be substantially free from organic acids, organic acid anhydrides and organic esters. In some embodiments, the phase change material is substantially free from all organic compounds having a molecular weight of less than 200 Da. For the purposes of the present invention, substantially free indicates less than 0.1% by weight and preferably less than 0.01% by weight.

### Preparation of the Phase Change Material

The phase change material of the present invention may be prepared by a method which comprises combining all of the components of the phase change material.

Preferably, the method comprises preparing a pre-mixture of all of the components in the phase change material apart from the gelling agent, and then adding the gelling agent to the mixture. By carrying out a pre-mixing step, an even dispersion of components may be obtained before the gelling agent is added.

In some embodiments, the method may comprise a preliminary step of selecting a ternary salt-water solution by:
(a) selecting one or more first salts, e.g. based on the phase change temperature and/or latent heat of a solution of the first salt;
(b) forming a series of ternary salt-water solutions by combining a solution each of the one or more first salts with a solution of each of at least two second salts;
(c) measuring the phase change temperature and/or latent heat of each of the series of ternary salt-water solutions;
(d) selecting a ternary salt-water solution based on the measured values.

The solutions of the first and second salt referred to in steps (a) to (d) are preferably eutectic solutions.

In step (a), the first salt may be selected because the solution of the first salt has a phase change temperature which is at least 1° C., preferably at least 2° C., and more preferably at least 2.5° C. higher than the target phase change temperature of the phase change material. The first salt may be selected because the solution of the first salt has a phase change temperature which is up to 10° C., preferably up to 7° C., and more preferably up to 5° C. higher than the target phase change temperature of the phase change material. Thus, the first salt may be selected because the solution of the first salt has a phase change temperature which is from 1 to 10° C., preferably from 2 to 7° C., and more preferably from 2.5 to 5° C. higher than the target phase change temperature of the phase change material.

Where multiple first salts are identified as having a suitable phase change temperature in step (a), the one or more with the highest latent heat may be selected.

Where multiple first salts are selected in step (a). step (b) comprises forming a series of ternary salt-water solutions by combining a solution of each of the first salts with a solution of at least two second salts. For instance, where two first salts are selected, and three second salts are screened, the series of solutions will be made up of six ternary salt-water solutions. Where two first salts are selected, and five second salts are screened, the series of solutions will be made up of 10 ternary salt-water solutions.

Step (b) may also comprise including ternary-salt water solutions containing different ratios of a solution of a first salt to a solution of a second salt for each salt pair. For instance, where two first salts are selected and five second salts are screened, and three different ratios of first solution to second solution are tested for each salt pair, the series of ternary salt-water solutions will be made up of 30 ternary salt-water solutions.

The ternary salt-water solution may be selected in step (d) because it has a phase change temperature within 3° C., preferably within 2° C., and more preferably within 1° C. of the target phase change temperature of the phase change material.

Where multiple ternary salt-water solutions are identified has having a suitable phase change temperature in step (d), the one with the highest latent heat may be selected. Preferably, the latent heat of the ternary salt-water solution is higher than that of the solution of the first salt.

### Cold Storage Packs

The phase change material of the present invention may be used in a cold storage pack which comprises a container in which the phase change material is held.

Suitable materials include metal (e.g. stainless steel) and plastic containers, though plastic containers are preferred. The containers may be used portable, e.g. so that they can be moved from a refrigerator to an environment to be cooled such as the storage area of a goods transportation vehicle.

The cold storage pack may be prepared by filling the container with the phase change material of the present invention.

Alternatively, the container may be filled with a mixture of all of the components in the phase change material apart from the gelling agent, and then adding the gelling agent to the mixture in the container. This allows the container to be filled with a low viscosity solution, which is easier to handle than the already gelled mixture. The phase change material is preferably mixed, e.g. by shaking, stirring or other agitation, during gelation. This helps to ensure that the gelled agent is evenly distributed.

### Uses

The phase change material of the present invention may be used as a cold storage material. The cold storage material may be for maintaining an environment at a temperature of from −15 to −40° C. These environments are particularly suitable for storing cold-chain products including perishable goods such as foodstuffs and medicines.

Before use, the phase change material is cooled to a temperature below its phase change temperature so that it is in a solid form. During use, energy is absorbed from the surroundings by the phase change material, thereby cooling the environment. Since the phase change materials of the present invention may exhibit a high latent heat of enthalpy, they may absorb a lot of energy from their surrounding before the transition from a solid to liquid state at their phase change temperature is complete. Once the phase change material has been used, it is preferably cooled once again to below its phase change temperature for further use.

One of the advantages of the present invention is that the phase change material exhibits good cycling stability, meaning that it can be reused many times with minimal loss of performance. For instance, the phase change material of the present invention may be subjected to at least 10, preferably at least 20, and more preferably at least 30 cycles from solid to liquid to solid whilst still maintaining the same phase change temperature (e.g. ±5° C. as compared to the material before the first cycle) and the same latent heat (e.g. ±10 kJ/kg as compared to the material before the first cycle). This is unlike many prior art cold storage materials which can lose efficacy with use.

### EXAMPLES

The present invention will now be illustrated by way of the following non-limiting examples.

In the examples, phase change temperature was measuring using differential scanning calorimetry (DSC). Samples for analysis using DSC were prepared by placing approximately 1 to 10 mg of the sample in a 40 μl aluminium crucible. DSC was carried out using a Mettler Toledo DSC2+ with the following settings: temperature range of 25 to −60° C. and a heating/cooling rate of 5° C./min. An endothermic peak or exothermic peak indicated the occurrence of the phase change. The collected data was analysed with the analysis software by Mettler Toledo.

Latent heat of enthalpy was also measured using DSC, using the method outlined above in connection with phase change temperature.

Specific heat was measured using two curve method (also known as the sapphire method), with DSC also carried out using the method outlined above in connection with phase change temperature.

### Example 1: Screening of Phase Change Materials for Use in Cold Storage Applications at −20° C.

Phase change materials were screened to identify preferred candidates for use in a cold storage application where a chilled environment of −20° C. is desired. To give these temperatures, a target phase change temperature of −25° C. was selected.

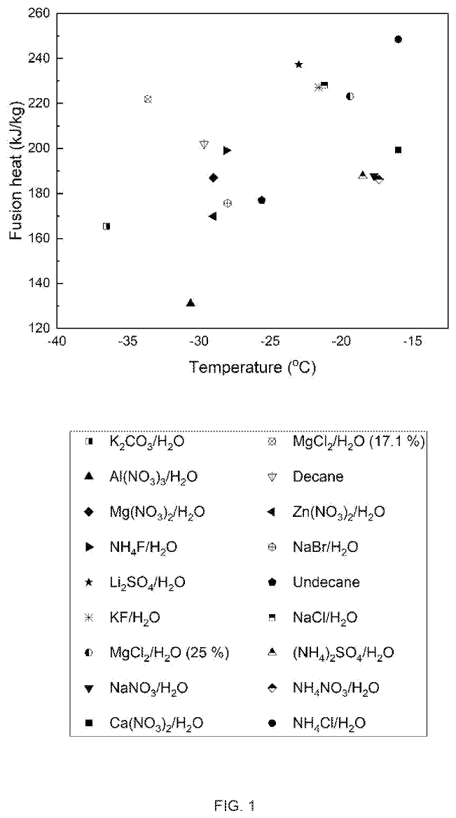

FIG. 1 shows a graph of fusion heat against phase transition temperature of various organic materials and eutectic salt solutions. The values shown in the graph were obtained from literature. It can be seen that while the organic materials—which are commonly used in phase change materials—such as undecane exhibit good phase change temperatures, their fusion heat is relatively modest.

Sodium chloride was therefore selected for use in the phase change material. Sodium chloride exhibits good fusion heat values and, though a sodium chloride eutectic solution has a phase change temperature of between −22 and −23° C. (i.e. slightly higher than the target phase change temperature of −25° C.) it was believed that this could be lowered by combining the sodium chloride with a second eutectic salt solution.

A eutectic solution of sodium chloride was then combined with a eutectic solution of a second salt to give a ternary salt-water solution. The first and second salt eutectic solutions were combined in the ternary salt-water solution in ratios of first:second eutectic salt solutions of from 3:1 to 1:3. A variety of second salts were tested but, to minimise the risk of new salts forming, each of the second salts either had a sodium cation or a chloride anion.

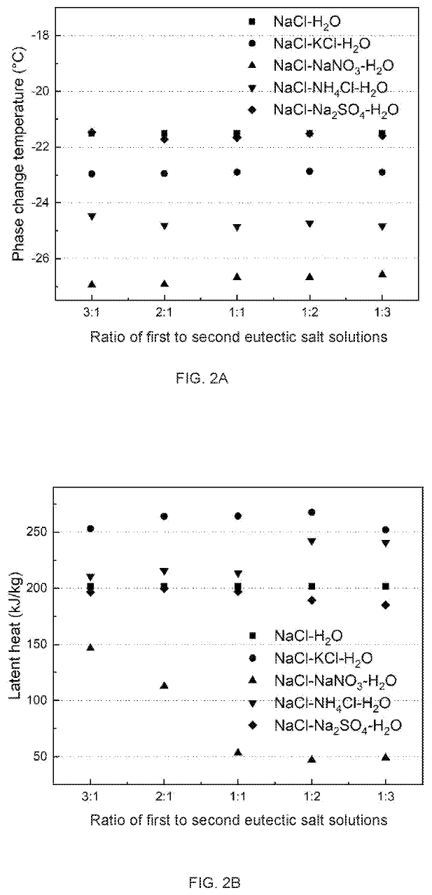

The phase change temperature and latent heat of the different ternary salt-water solutions were assessed using differential scanning calorimetry (DSC). The phase change temperature and latent heat of the different ternary salt-water solutions are shown in FIGS. 2a and 2b, respectively. For comparison, the phase change temperature and latent heat of eutectic sodium chloride is also shown.

It can be seen from FIG. 2a that the phase change temperature of each of the ternary salt-water solutions was lower than that of eutectic sodium chloride, and that the ratio in which the solutions were combined did not have a large effect on this. Larger reductions in phase change temperature were generally observed where the different in phase change temperature of the eutectic solutions was small.

It can be seen from FIG. 2b that, unlike phase change temperature, the latent heat of the ternary solutions was in some cases higher and in other cases lower than that of eutectic sodium chloride. The ratio in which the eutectic solutions of the first and second salts were combined also had a significant effect on latent heat. The ternary solutions in which potassium chloride and ammonium chloride shower a larger latent heat than that of eutectic sodium chloride. Since the sodium chloride-ammonium chloride system also exhibit a highly desirable phase change temperature, this ternary salt-water solution was chosen for further development.

### Example 2: Comparison of a Phase Change Material of the Invention with Commercially Available Cold Storage Materials

PCM 1 is a phase change material according to the present invention, and was prepared as described previously herein.

Two commercially available cold storage materials, PCM A and PCM B, were evaluated. PCM A and PCM B are solutions of different blends of salts and have reported phase change temperatures of −26° C. and −32° C., respectively.

The phase change temperature, latent heat of enthalpy, and specific heat of the commercially available cold storage materials and the phase change material PCM 1 were tested. The measured results are shown in the following table (with reported values for the commercial materials shown in brackets):

| | PCM A | | PCM B | | PCM 1 |
|---|---|---|---|---|---|
| Phase change temperature | −26.3 | (−26.0) | −33.0 | (−32.0) | −24.8 |
| ° C. | | | | | |
| Latent heat of enthalpy | 173 | (260) | 131 | (243) | 220 |
| kJ/kg | | | | | |
| Specific heat | 2.15 | (3.6) | 3.61 | (2.95) | 3.25 |
| J/mol K | | | | | |

It can be seen that there are significant differences between the reported and measured properties of the commercial products. It can be seen that PCM 1 and PCM A exhibit very similar phase change temperatures, yet the latent heat of enthalpy and specific heat are significantly higher for PCM 1.

1. A phase change material for use as a cold storage material, said phase change material comprising:
a salt-water solution comprising a first salt, a second salt, and water;
a gelling agent;
a thermal conductivity enhancer; and
a nucleation agent.

2. The phase change material of claim 1, wherein the salt-water solution is a ternary or quaternary salt-water solution and preferably a ternary salt-water solution.

3. The phase change material of claim 1, wherein the cations or the anions, and preferably the anions, in the first and second salts are the same.

4. The phase change material of claim 1, wherein the cations in the first and second salt are selected from alkali metal (e.g. lithium, sodium and potassium), alkaline earth metal (e.g. calcium and magnesium), transition metal (e.g. zinc, iron and copper) and ammonium cations; preferably from alkali metal, alkaline earth metal and ammonium cations; and more preferably from alkali metal and ammonium cations.

5. The phase change material of claim 1, wherein the anions in the first and second salt are selected from nitrate, sulfate, hydrogen sulfate, thiosulfate, phosphate, hydrogen phosphate, dihydrogen phosphate, carbonate, hydrogen carbonate, hydroxide, formate, acetate and halide (e.g. chloride, bromide and iodide) anions, and preferably from halides.

6. The phase change material of claim 1, wherein the first and second salts are inorganic salts.

7. The phase change material of claim 1, wherein the first salt is sodium chloride and preferably the second salt is selected from ammonium chloride, potassium chloride and sodium sulfate, preferably from ammonium chloride and potassium chloride, and more preferably is ammonium chloride.

8. The phase change material of claim 1, wherein the salt-water solution is a combination of a first eutectic solution of the first salt, a second eutectic solution of the second salt and, where present, further eutectic solutions of any further salts.

9. The phase change material of claim 8, wherein:
the phase change temperature of the phase change material may be from 1 to 10° C., preferably from 2 to 7° C., and more preferably from 2.5 to 5° C. lower than that of the first eutectic solution; and/or
the latent heat of the phase change material may be at least 10 kJ/kg, preferably at least 20 kJ/kg, and more preferably at least 30 kJ/kg higher than that of the first eutectic solution.

10. The phase change material of claim 1, wherein the ratio, by weight, of the first salt to the second salt is from 1.5:1 to 4:1, preferably from 2:1 to 3:1, and more preferably 2.25:1 to 2.75:1.

11. The phase change material of claim 1, wherein the ternary salt-water solution comprises the first and second salts in a total amount of from 15 to 35%, preferably 20 to 30%, and more preferably from 22 to 28% by weight.

12. The phase change material of claim 1, wherein the ternary salt-water solution is present in the phase change material in an amount of from 90 to 97%, preferably from 92 to 96.5%, and more preferably from 93 to 96% by weight.

13. The phase change material of claim 1, wherein the phase change material comprises water in an amount of at least 60%, preferably at least 65%, and more preferably at least 70% by weight.

14. The phase change material of claim 1, wherein the gelling agent is selected from organic gelling agents (e.g. carboxymethyl cellulose, polyacrylamide, starch and xanthan), silica dioxide and mixtures thereof.

15. The phase change material of claim 1, wherein the gelling agent is present in the phase change material in an amount of from 1 to 8%, preferably from 2 to 7%, and more preferably from 3 to 6% by weight.

16. The phase change material of claim 1, wherein the thermal conductivity enhancer is selected from carbon-based materials (e.g. graphite such as expansion graphite, carbon nanotubes and carbon fibres), metal-based material (e.g. metal powder), carbides, and combinations thereof.

17. The phase change material of claim 1, wherein the thermal conductivity enhancer is present in the phase change material in an amount of from 0.05 to 2%, preferably from 0.1 to 1%, and more preferably from 0.25 to 0.75% by weight.

18. The phase change material of claim 1, wherein the nucleation agent is selected from isotypic nucleation agents (e.g. borax), non-isotypic nucleation agents (e.g. dilatometer and silica) and mixtures thereof.

19. The phase change material of claim 1, wherein the nucleation agent is present in the phase change material in an amount of from 0.05 to 2%, preferably from 0.1 to 1%, and more preferably from 0.25 to 0.75% by weight.

20. The phase change material of claim 1, wherein the phase change material has a phase change temperature of from −70° C. to 0° C., preferably from −40 to −20° C., and more preferably from −26 to −24° C.

21. The phase change material of claim 1, wherein the phase change material has a latent heat of enthalpy of greater than 150 kJ/kg, preferably greater than 175 kJ/kg, and more preferably greater than 200 kJ/kg.

22. The phase change material of claim 1, wherein the phase change material is substantially free from organic acids, organic acid anhydrides and organic esters, and is preferably substantially free from organic compounds having a molecular weight of less than 200 Da.

23. A method of preparing the phase change material of claim 1, said method comprising comprises combining all of the components of the phase change material, preferably by:
preparing a pre-mixture of all of the components in the phase change material apart from the gelling agent; and then
adding the gelling agent to the mixture.

24. A cold storage pack which comprises:
a phase change material as defined in any of claim 1; and
a container, preferably a plastic container, in which the phase change material is held.

25. Use of a phase change material as defined in claim 1 as a cold storage material for maintaining an environment at a temperature of from −15 to −40° C.
